(19) United States
(12) Patent Application Publication
(10) Pub. No.: US 2004/0070860 A1
(43) Pub. Date: Apr. 15, 2004

(54) Automotive audio box

(76) Inventors: Tom Perusse, Corcoran, MN (US); Julie Perusse, Corcoran, MN (US)

Correspondence Address: Christopher G. Frank, Nawrocki, Rooney & Sivertson, P.A., Broadway Place East, Suite 401, 3433 Broadway Street Northeast, Minneapolis, MN, 55413, US

(21) Appl. No.: 10/457,771

(22) Filed: Jun. 9, 2003

Related U.S. Application Data
(63) Continuation of application No. 09/531,316, filed on Mar. 20, 2000, now abandoned.

(51) Int. Cl. G11B 5/00

(52) U.S. Cl. 360/12

(57) ABSTRACT

Disclosed is a device for use in conjunction with the marketing of automobiles including a protective case including a u-shaped bracket for secured mounting over automobile door window, the case containing mechanism for playback of messages relating to the characteristics and price of an automobile for sale, the playback mechanism being accessible through a cover in the case adjacent the window accessible when the case has been removed from the window but not when the case is in place on the window; and activating controls for the playback mechanism.

### FIELD OF THE INVENTION

The Present Invention relates to recording and playback devices and more particularly to a special use recording and playback device for attachment to an automobile in a new and/or used car sales lot, as well as personal use in selling automobiles.

### BACKGROUND OF INVENTION

A wide variety of recording devices have been known in the past. During the early history of recording devices, the recording was a complicated process. Initially the recording was done on steel wire by placing magnetic impressions on the wire. As time went along Polymer Disks were impressed with surface irregularities that provided tone variations as a recording.

The Polymeric Disks brought the recording world into mass production, since the disks could be mechanically created and did not need to be individually recorded. Later magnetic tapes were invented which permitted ready recording in the field rather than requiring the complex equipment of a recording studio. With this development conferences, speeches, telephone conversations and the like could be recorded with a portable recorder. These tape recording devices became common place throughout education, business, and even in the home. Students record class lectures, rather than to take detailed notes. Business people record business conferences, without the need for detailed minutes. Families record gatherings of the family. These recording devices were general in nature and could be carried in a brief case or even in one's suit jacket pocket.

As time went along special use recordings were created. Today recording devices are found in a wide variety of special use situations. An illustration are telephone devices which provide a short recorded message to a telephone caller. These devices permit the telephone caller to leave a message requesting a return telephone call. Similar recorders are provided as surveillance equipment in businesses such as grocery stores, gas stations and the like. Such surveillance equipment may be activated by sound. Such surveillance may even automatically dial the police in the case of a break in.

The present invention is a special use recording device for use in the sales of automobiles, providing a sales pitch without the intimidating presence of a salesman.

### SUMMARY OF THE INVENTION

The present invention relates to a recording device specially adapted for use in used car lots. The device is designed for quick and yet secure attachment to an automobile. The device carries a pre-recorded message about the automobile, its history, its characteristics (mileage etc.) and its sales price. The device may be used on automobiles in used car and new car lots, as well as, on automobiles offered for sale by the owner. In the latter case the automobile may be parked on the street with the device attached.

The device includes a box with a u-shaped rod or strap integrally attached to the box. The unshaped rod or strap fits snugly over the glass of a car door window. The window is partially lowered and the u-shaped rod is mounted over the window. The window is then raised to a position very close to being closed thereby entrapping the device. The box may include an opening for access to the interior of the box. The opening may be covered by a removable plate, e.g., a door, on the side adjacent to the window. This arrangement places the removable plate in a secure position when the device is mounted to the adjacent window. The box includes a playback mechanism adapted to receive and play a small cassette such as those used in hand dictators. For example, the recording and playback mechanism for an Olympus Pearlcorder S924 may be adapted to be used in the present invention. This mechanism is adapted to receive a microcassette. A control may be included that extends through the side walls of the box which is remote from the window, making the controls accessible to a person considering the purchase of the automobile.

IN THE DRAWINGS:

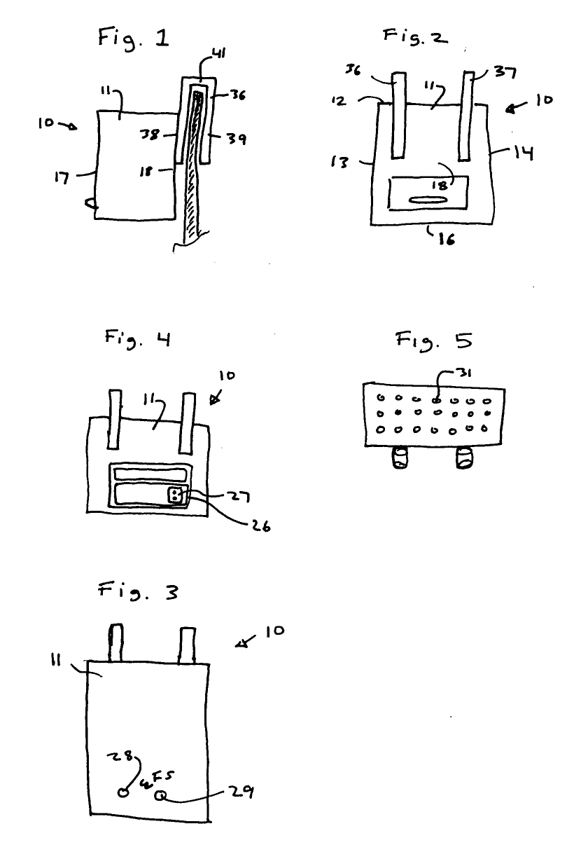

FIG. 1 shows a side view of the device of the present invention mounted over the window of a car door;

FIG. 2 shows a plan view of the present invention from the side adjacent from the window;

FIG. 3 shows a plan view of the present invention from the side remote from the window;

FIG. 4 shows a view similar to FIG. 2 except with the access door removed;

FIG. 5 shows a bottom view of the device illustrating the surface through which the sound is emitted; and

FIG. 6 shows a preferred embodiment of the invention.

### DETAILED DESCRIPTION OF THE PRESENT INVENTION

The Automotive Audio Box 10 of the present invention is illustrated in FIGS. 1-5. The audio box 10 has a case 11 that may be rectangular in shape as shown in FIGS. 1-5. The case 11 may include a plurality of integral metal plates serving as side walls 11,12,13, and 16 as well as a front plate 17 and a rear plate 18. Rear plate 18 includes an access opening 21 (FIG. 4). The access opening 21 may be suitably covered by a plate or door 22 (FIG. 2). The door 22 may be locked in place by a conventual latch 23. A recording device or playback mechanism 26 is deposed in box 11 (FIG. 4). The playback device 26 may include a control 28 for activating the playback of the recorded message.

The playback mechanism may be provided with an automatic rewind on completion of the played message. If desired the playback mechanism 26 may be provided with both an English message, as well as, other desired languages such as: French and or Spanish. The control 29 may serve to permit selection of the desired language.

The case 11 may include a plurality of openings 31 defined in the lower wall 16 through which the sound may be emitted. In other words the speaker of the playback device 36 may be deposed immediately above of the lower wall 16 and the sound passes through the openings 31.

The device 10 includes a u-shaped bracket 36 constructed of metal strap 38 for mounting on the car window. The bracket 36 may alternatively be constructed of a polymer, plastic or hard rubber. The bracket 36, for example, includes a pair of leg 38 a bight 41 (FIG. 1). The leg 38 is integrally secured to the wall 18 such as by welding. The leg 38 is sufficiently spaced to permit snug reception of the window 42. The u-shaped bracket may be a plurality of metal straps.

### USE OF THE PRESENT INVENTION

The Automotive Audio Box 10 of the present invention may be used by recording the description or characteristics of a particular automobile. For example the recording may be state that the automobile is a 1983 Ford that was garaged by the owner and that the automobile was cared for by the Mobil Service Station at 36th Avenue and Excelsior Boulevard. The recording may state that Oil changes were routinely carried out every 3,000 miles and that the automobile had not been in an accident, that the true mileage was verified by the owner at 70,000 miles.

The cassette 27 may be pre-recorded using a conventional office dictator machine. Alternatively the mechanism 26 may be provided with recording capabilities so that the message about the car is recorded with the cassette 27 already loaded into the device 10. Once the desired message is in place on the cassette 27, the cassette is loaded into the box through opening 21 and the door 19 may be put in place to secure the opening. The controls 28 and 29 extend through the plate 17 for purposes hereinafter described. The device 10 is mounted over the window 46 as illustrated in FIG. 1. The window 46 is then raised until the bight 41 of bracket 36 engages the rail 47 in the upper portion of the car door. The window being raised to this position traps the device 10 in place so it cannot be stolen. If the car door 10 is then locked the device 10 is secured from any theft.

The recording is activated by depressing the button 28. The recorded voice message is conveyed to the potential costumer. The control 29 may be a knob or button and may be adjusted for the desired language such as English, French, or Spanish. The knob 29 activates controllers such that the portion of the cassette 27 is played using the desired language.

### A PREFERRED EMBODIMENT OF THE PRESENT INVENTION

A preferred embodiment 110 is illustrated in FIG. 6. Device 110 includes a box 111 constructed of any suitable material such as metal, plastic or rubber. The device has a bracket 136 adapted for securement over an automobile window. The bracket has a leg 138 and a bight 138. The device 110 has recording and play back mechanism similar to that described with respect to the device 10. 110 how ever includes mechanism 151 to provide information in the English language, mechanism 152 to provide information in a second language and mechanism 153 to record a message from the potential customer.

All various modifications may be made without departing from the broader scope of the present invention of present invention shown in FIGS. 1-6.

What is claimed is:

1. A device for use in conjunction with the marketing of automobiles, said device comprising:
a protective case including container means having first side and a door disposed in said first side, said door being adapted to provide access into the interior of said container means, said container means further including a second side opposite said first side;
means for play back of messages relating to an automobile for sale, said means for play back being disposed within said case and accessible through said door; and means for control of said playback means for activating said playback means, said control means being accessible through the second side of said container means;
a u-shaped retaining rod integral with said container means adjacent a first side of said container means, said u-shaped rod being adapted for mounting over an automobile window, whereby said container means may be mounted by placing the u-shaped rod over a lowered automobile window and secured to said automobile by raising said window thereby entrapping said unshaped rod and integral container means in place.

2. The device of claim 1 wherein said container means comprises a box and wherein said playback means is removable from said box through said door for purposes of recording a desired message regarding the characteristics of said automobile.

3. The device of claim 2 wherein said device includes means for recording a return message from a potential customer that has listened to said playback and desire to leave a recorded offer to purchase the automobile.

4. A device for use in conjunction with the marketing of automobiles, said device comprising:
a protective case including a box having first side and a door disposed in said first side, said door being adapted to provide access into the interior of said box, said box further including a second side opposite said first side;
means for play back of messages relating to the characteristics and price of an automobile for sale, said means for play back being disposed within said case and accessible through said door; and means for control of said playback means for activating said playback means, said control means being accessible through the second side of said box;
means for recording a return message from a potential customer that has listened to said playback and desires to leave a recorded offer to purchase the automobile; said recording means being activatable by control means extending through said second side of said box;
a unshaped retaining rod integral with said box adjacent a first side of said box, said u-shaped rod being adapted for mounting over an automobile window, whereby said box may be mounted by placing the u-shaped rod over a lowered automobile window and secured to said automobile by raising said window thereby entrapping said u-shaped rod and integral box in place.

5. A device of claim 4 wherein said box is constructed of metal.

6. The device of claim 4 wherein said box is constructed of polymer.

7. The device of claim r wherein said box is constructed of hard rubber.

8. A method for communicating marketing information for use in the sales of automobiles, said method comprising the steps of:
recording a message describing the automobile;
placing the recording in an enclosed mechanism, said mechanism comprising a protective case including a box having first side and a door disposed in said first side, said door being adapted to provide access into the interior of said box, said metal box further including a second side opposite said first side; means for play back of messages relating to the characteristics and price of an automobile for sale, said means for play back being disposed within said case and accessible through said door; and means for control of said playback means for activating said playback means, said control means being accessible through the second side of said box; means for recording a return message from a potential customer that has listened to said playback and desires to leave a recorded offer to purchase the automobile; said recording means being activatable by control means extending through said second side of said box; a u-shaped retaining rod integral with said box adjacent a first side of said box, said u-shaped rod being adapted for mounting over an automobile window, whereby said box may be mounted by placing the unshaped rod over a lowered automobile window and secured to said automobile by raising said window thereby entrapping said unshaped rod and integral box in place;
activating the playback means to play the recording describing the automobile.
